(19) United States
(12) Patent Application Publication
(10) Pub. No.: US 2011/0253463 A1
(43) Pub. Date: Oct. 20, 2011

(54) MODULAR HYBRID ELECTRIC VEHICLE SYSTEM

(76) Inventor: Mark Eric Smith, Temecula, CA (US)

(21) Appl. No.: 12/760,175

(22) Filed: Apr. 14, 2010

(51) Int. Cl. B62D 59/04

(52) U.S. Cl. 180/11

(57) ABSTRACT

A modular hybrid electrical vehicle system may comprise an electric vehicle and a detachable power plant. The detachable power plant may be operable to externally attach to and provide power for the electric motor vehicle.

### CROSS REFERENCE TO RELATED APPLICATIONS

The present application claims the benefit of U.S. Provisional Patent Application No. 61/168,708, filed on Apr. 13, 2009, which is incorporated herein by reference in its entirety.

### BACKGROUND OF THE INVENTION

The present invention generally relates to electric systems and, more specifically, to a modular hybrid electric vehicle system.

Currently, serial hybrid electrical vehicles generally have both a fossil fuel or bio fuel internal combustion engine and electric generator as well as an electric motor drive train. While the serial hybrid electric vehicle may require the use of the fossil fuel or bio fuel internal combustion engine and electric generator for longer trips, the serial hybrid electric vehicle may only need to use the electric motor drive train for short local trips. However, even when the fossil fuel or bio fuel internal combustion engine and electric generator is not being used, such as when the vehicle is being powered solely by the electric motor drive train during short trips, the vehicle must still carry the additional weight of the fossil fuel or bio fuel internal combustion engine and electric generator, thereby decreasing the efficiency of the vehicle.

Further, while pure electric vehicles may be more efficient than hybrid electrical vehicles because they do not have to carry the extra weight of the fossil fuel or bio fuel internal combustion engine and electric generator, pure electric vehicles generally have limited range as compared with hybrid electrical vehicles, thereby limiting broad acceptance of pure electric vehicles.

As can be seen, there is a need for a vehicle that has the efficiency of pure electric vehicles while having the range and power of hybrid electric vehicles.

### SUMMARY OF THE INVENTION

In one aspect of the present invention, a system may comprise an electric motor vehicle and a detachable power plant operable to externally attach to and provide power for the motor vehicle.

In another aspect of the present invention, a method for powering an electric motor vehicle may comprise connecting a detachable power plant to the electric motor vehicle, and operating the electric motor vehicle to cause the detachable power plant module to supply power to the electric motor vehicle.

These and other features, aspects and advantages of the present invention will become better understood with reference to the following drawings, description and claims.

### BRIEF DESCRIPTION OF THE DRAWINGS

FIG. 1 shows a side elevation view of a first embodiment of the invention;

FIG. 2 shows a side elevation view of a modification of the first embodiment of the invention;

FIG. 3 shows a side elevation view of a second embodiment of the invention;

FIG. 4 shows a side elevation view of a third embodiment of the invention;

FIG. 5 shows side elevation view of a fourth embodiment of the invention;

FIG. 6 shows a side elevation view of a fifth embodiment of the invention;

FIG. 7 shows a side elevation view of a sixth embodiment of the invention;

FIG. 8 shows a top plan schematic view of a detail of fifth and sixth embodiments of the invention;

FIG. 9 shows a block diagram showing how to convert existent vehicles to the scheme of the invention;

FIG. 10 shows a block diagram showing the control system of the invention; and

FIG. 11 shows a schematic diagram showing the electrical path of the fifth embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a modular serial hybrid electric vehicle system that may maximize the efficiency and utility of electric vehicles.

Embodiments of the present invention may provide for the ability for fossil fuel or bio fuel internal combustion engine and electric generator power plant to be easily connected to and disconnected from electric vehicles as necessary, so that an electric vehicle may be powered by the most efficient means necessary depending on the intended usage of the electric vehicle. By separating the fossil fuel or bio fuel internal combustion engine and electric generator power plant and the fuel tank that carries fuel for the power plant from the electric drive vehicle, embodiments of the present invention may take advantage of all of the advances of current plug-in serial hybrid electric vehicle technology, so that the electric drive vehicle may be powered by batteries for short-range trips while being easily connectable with an external electric power plant module to power the electric drive vehicle for longer distance trips.

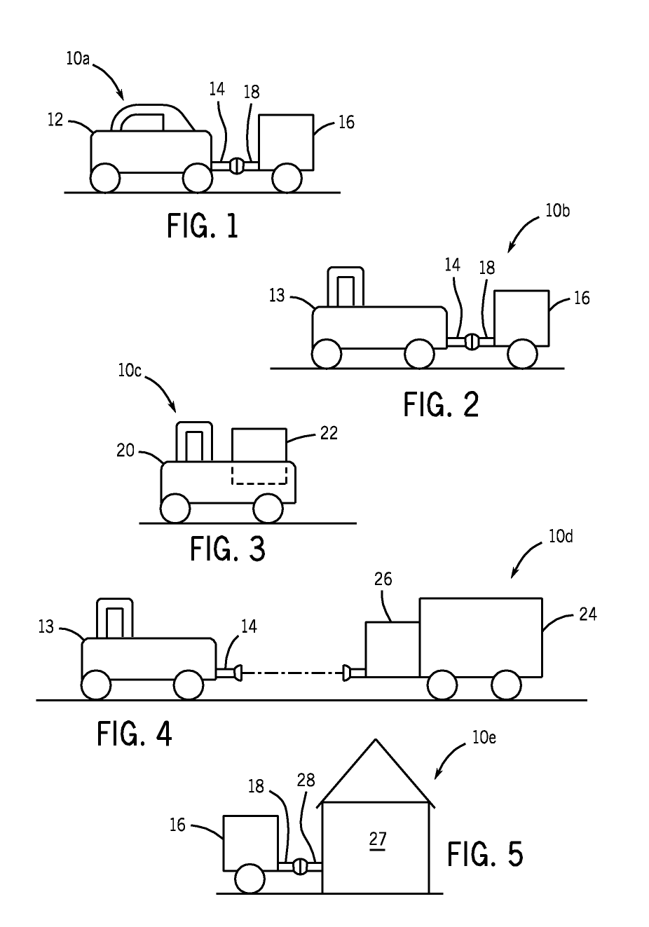

With reference to FIG. 1, a first embodiment 10a of the present invention may provide a car 12, such as an electric drive car that is propelled by an electric motor powered by a battery, that may be connected to a electric power plant module 16 in the form of a trailer via a vehicle coupling 14 coupled to a power module coupling 18, so that the car 12 may pull the power module 16. The vehicle coupling 14 may be external to the car 12 while the power module coupling 18 may be external to the power module 16. The power module 16 may comprise a fossil fuel or bio fuel internal combustion engine and electric generator and a fuel tank operable to hold fossil fuel or bio fuel for powering the fossil fuel or bio fuel internal combustion engine. The power module 16 may also comprise an electric fuel cell or an auxiliary battery set.

Further, the power module 16 may also be operable to power the car 12, such as by recharging the battery that powers the electric motor drive train of the car 12, or by directly powering the electric motor drive train of the car 12.

With reference to FIG. 2, a modification 10b of the first embodiment 10a of the present invention may provide for a pickup truck 13, such as an electric drive pickup truck, that is connected to a power module 16 in the form of a trailer via a vehicle coupling 14 coupled to a power module coupling 18, so that the pickup truck 13 may pull the power module 16.

With reference to FIG. 3, a second embodiment 10c of the present invention may provide for a truck 20 that may carry a power module 22 on the truck 20. As shown in FIG. 3, there may be no need to pull the power module 22 behind the truck 20.

With reference to FIG. 4, a third embodiment 10d of the present invention may provide for a power module 26 that may be connected to a recreational vehicle 24, and a pickup truck 13 that may couple with the power module 26 and the recreation vehicle 24 via vehicle coupling 14.

With reference to FIG. 5, a fourth embodiment 10e of the present invention may provide for a power module 16 in the form of a trailer with power module coupling 18 that may couple to a building 27 via a building coupling 28, so that the power module 16 may serve as a backup generator and/or power source for the building 27.

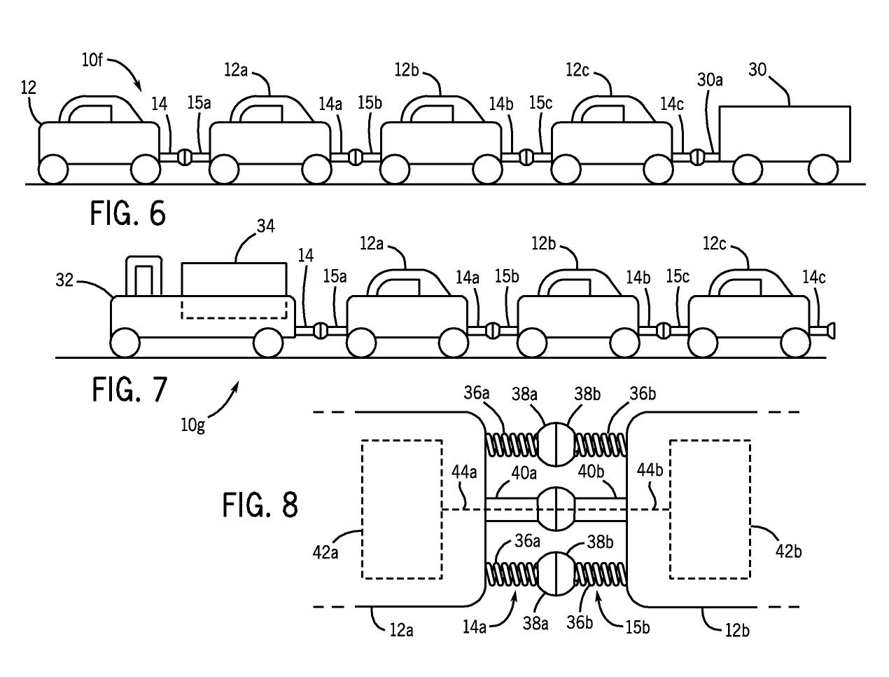

With reference to FIG. 6, a fifth embodiment 10f of the present invention may provide for cars 12, 12a, 12b, and 12c to be daisy chained together in a commuter road train control network via couplings 14, 14a, 14b, 14c, 15a, 15b, and 15c along with a high capacity power module 30 that is chained via high capacity power coupling 30a to provide power to the cars 12, 12a, 12b, and 12c. The speed, propulsion, and braking of the individual cars 12a, 12b, and 12c may be synchronized with the lead car 12. Further, the lead car 12 may directly control the high capacity power module. While cars 12a, 12b and 12c may have the ability to individually control an attached power plant when not daisy chained in the commuter road train control network, their individual power plant controls may not be available in the daisy chained configuration.

With reference to FIG. 7, a sixth embodiment 10g of the present invention may provide for a truck 32 daisy chained to cars 12a, 12b, and 12c via couplings 14, 14a, 14b, 14c, 15a, 15b, and 15c. In this embodiment 10g, a power plant module 34 that provides power to the truck 32 and the cars 12a, 12b, and 12c may be connected to and carried on the truck 32 instead of being daisy chained with the truck 32 and the cars 12a, 12b, and 12c.

With reference to FIG. 8, a first car 12a may be connected to a second car 12b via couplings 14a and 15b, in order to enable the articulated daisy chaining of the cars, such as shown in FIGS. 6 and 7. Coupling 14a may comprise a pair of spring couplings 36a, a pair of coupling members 38a, and electrical coupling 40a, while coupling 15b may also comprise a pair of spring couplings 36b, a pair of coupling members 38b, and electrical coupling 40b. The pair of spring couplings 36a may connect to the pair of spring couplings 36b via coupling members 38a and 38b, while the electrical coupling 40a may connect to the electrical coupling 40b. Further a motor/controller unit 42a on car 12a may be connected to a motor/controller unit 42b on car 12 via power/control lines 44a and 44b that may run through the electrical couplings 40a and 40b.

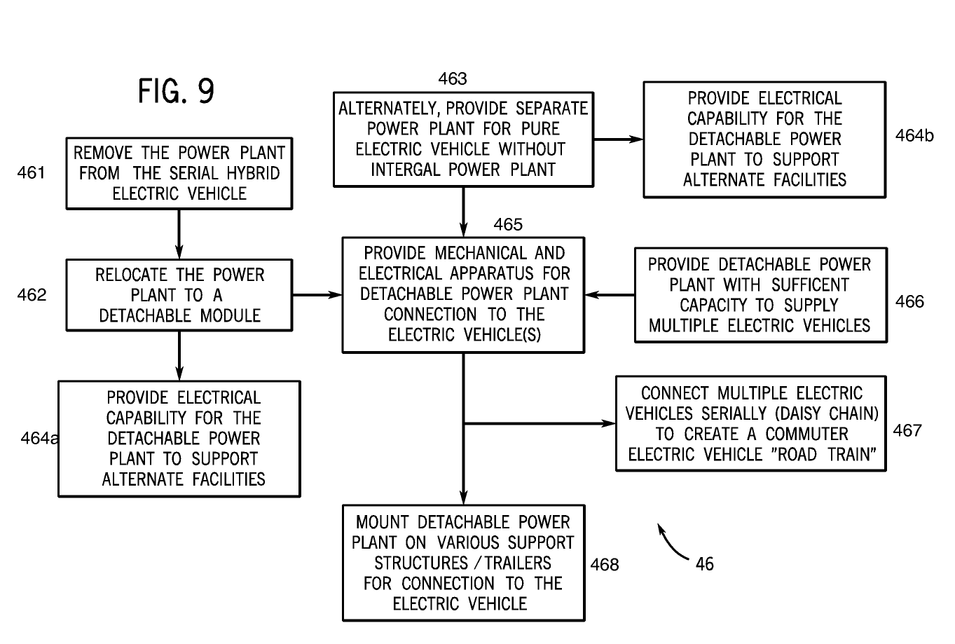

With reference to FIG. 9, a block diagram 46 may show how existing vehicles may be converted to and utilized as a modular hybrid electric vehicle.

At 461, the power plant, such as a fossil fuel motor/generator and a fuel tank, may be removed from the integral position in the serial hybrid electric vehicle.

At 462, the removed power plant may be relocated to a detachable power plant module, such as a trailer or a slide-in component for the original vehicle.

At 463, alternatively, for purely electric vehicles without integral power plants, a separate power plant in a detachable power plant module may be provided.

At 464a and 464b, electrical capabilities may be provided for the detachable power plant module so that the module may also serve as a residential emergency power source, construction electrical power source, or recreational vehicle electrical power source when not required for an electrical vehicle connection.

At 465, a mechanical attachment apparatus, such as a trailer hitch or slide-in rails, as well as an electrical connection apparatus, may be provided for the detachable module. The mechanical attachment apparatus may be operable to connect the module to the original vehicle while the electrical connection apparatus may be operable to provide primary battery support to the vehicle as well as to provide power plant control/status/alarms information between the vehicle and the power plant module.

At 466 and 467, the detachable power plant module may be provided with sufficient capacity to provide battery support for multiple electric vehicles that may be serially connected (“daisy chained”) into a commuter electrical vehicle “road train”, and the detachable power plant module may also be provided with the necessary electrical and mechanical apparatuses to be able to connect to the commuter electrical vehicle “road train”.

At 468, the detachable power plant module may be mounted on various support structures and trailers, such as pickup beds, recreational vehicle trailers, contractor “tool crib” trailers, service trailers, long haul support trailers, and delivery trailers, for connection to an electrical vehicle as may be necessary.

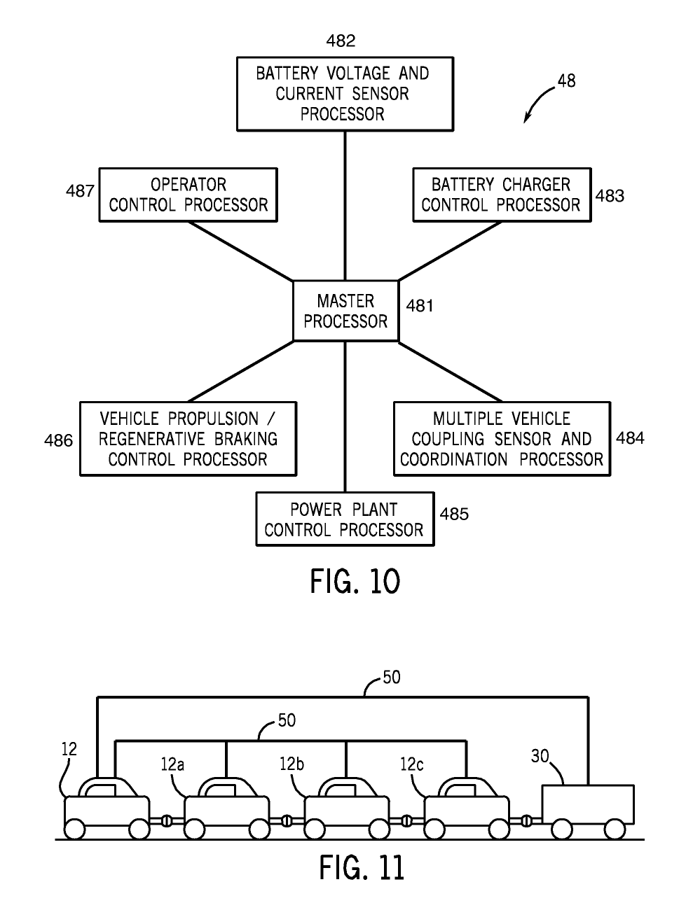

With reference to FIG. 10, a block diagram 48 may show a control system in accordance with embodiments of the present invention. As shown in FIG. 10, the control system may comprise a master processor 481 that may communicate with and control a battery voltage and current sensor processor 482, a battery charger control processor 483, a multiple vehicle coupling sensor and coordination processor 484, a power plant control processor 485, a vehicle propulsion/regenerative braking control processor 486, and an operator control processor 487.

With reference to FIG. 11, a lead car 12 may draw power from a high capacity power module 30 via an electrical path 50 and may distribute that power and synchronized drive control to cars 12a, 12b, and 12c via an electrical path 50.

In accordance with embodiments of the present invention, various computer hardware, computer software, and networking systems, as well as various mechanical systems and technologies may be employed in implementing the modular hybrid electric vehicle system.

It should be understood, of course, that the foregoing relates to exemplary embodiments of the invention and that modifications may be made without departing from the spirit and scope of the invention as set forth in the following claims.

We claim:

1. A system comprising:
An electric motor vehicle; and
a detachable power plant operable to attach externally to and provide power for the electric motor vehicle.

2. The system of claim 1, further comprising:
an attachment apparatus operable to connect the detachable power plant to the electric motor vehicle.

3. The system of claim 1, wherein the electric motor vehicle includes an electric motor drive train powered by a battery that is operable to power the electric motor vehicle without fossil fuel or bio fuel internal combustion engine and electric generator.

4. The system of claim 1, wherein the detachable power plant comprises a fossil fuel or bio fuel internal combustion engine and electric generator, a fuel cell, or auxiliary battery set.

5. The system of claim 1, further comprising:
additional electric motor vehicles daisy chained to the electric motor vehicle that is operable to receive power and synchronize drive control from the electric motor vehicle and the detachable power plant module.

6. The system of claim 5, wherein the detachable power plant is operable to provide sufficient power to power the electric motor vehicle and the additional electric motor vehicles.

7. The system of claim 1 wherein the power plant is mounted on a trailer.

8. The system of claim 1, wherein the detachable power plant is operable to connect to and provide emergency power to a building.

9. A method for powering a electric motor vehicle comprising:
connecting a detachable power plant module to the electric motor vehicle; and
operating the electric motor vehicle to cause the detachable power plant module to supply power to the electric motor vehicle.

10. The method of claim 9, wherein the detachable power plant module comprises a fossil fuel or bio fuel internal combustion engine and electric generator, fuel cell, or auxiliary battery set.

11. The method of claim 9 further comprising:
removing a fossil fuel or bio fuel internal combustion engine and electric generator from the electric motor vehicle; and
placing the fossil fuel or bio fuel internal combustion engine and electric generator in the detachable power plant module.

12. The method of claim 9, further comprising:
attaching additional electric motor vehicles to the electric motor vehicle.

13. The method of claim 9, wherein the electric motor vehicle is driven by an electric motor powered by a battery.

14. The method of claim 13, wherein the operating the electric motor vehicle further comprises operating the electric motor vehicle to cause the detachable power plant module to supply power to the battery.

15. The method of claim 9, wherein the detachable power plant module comprises a trailer being pulled by the electric motor vehicle.
